(19) United States
(12) Patent Application Publication
(10) Pub. No.: US 2004/0249810 A1
(43) Pub. Date: Dec. 9, 2004

(54) Small group sampling of data for use in query processing

(75) Inventors: Gautam Das, Redmond, WA (US); Brian Babcock, San Mateo, CA (US); Surajit Chaudhuri, Redmond, WA (US)

Correspondence Address: WATTS, HOFFMANN, FISHER & HEINKE CO., L.P.A., 1100 Superior Ave., Ste. 1750, Cleveland, OH, 44114, US

(73) Assignee: Microsoft Corporation

(21) Appl. No.: 10/453,135

(22) Filed: Jun. 3, 2003

(51) Int. Cl. G06F 17/30

(52) U.S. Cl. 707/5

(57) ABSTRACT

In decision support applications, the ability to provide fast approximate answers to aggregation queries is desirable. A disclosed technique for approximate query answering is sampling. For many aggregation queries, appropriately constructed biased (non-uniform) samples can provide more accurate approximations than a uniform sample. The optimal type of bias, however, varies from query to query. An approximate query processing technique is used that dynamically constructs an appropriately biased sample for each query by combining samples selected from a family of non-uniform samples that are constructed during a pre-processing phase. Dynamic selection of appropriate portions of previously constructed samples can more accurate approximate answers than static, non-adaptive usage of uniform or non-uniform samples.

### FIELD OF THE INVENTION

The present invention relates to approximate query processing of a database wherein aggregate queries such as Count and Sum are efficiently processed without resort to scanning of the entire, quite possible large database.

### BACKGROUND ART

In recent years, advances in data collection and management technologies have led to a proliferation of very large databases. These large data repositories are typically created in the hope that through analysis, such as data mining and decision support, they will yield new insights into the data and the real-world processes that created it. In practice, however, while the collection and storage of massive data sets has become relatively straightforward, effective data analysis has proven more difficult to achieve. One reason that data analysis successes have proven elusive is that most analysis queries, by their nature, require aggregation or summarization of large portions of the data being analyzed. For multi-gigabyte data repositories, this means that processing even a single analysis query involves accessing enormous amounts of data, leading to prohibitively expensive running times. This severely limits the feasibility of many types of analysis applications, including those that require timeliness or interactivity.

Ad hoc, exploratory data analysis is a cognitively demanding process that typically involves searching for patterns in the results of a series of queries in order to formulate and validate a hypothesis. This process is most effective when it can be performed interactively; long pauses between the time that a query is asked and the time when the answer is visible are likely to be disruptive to the data exploration process. While keeping query response times short is very important in many data mining and decision support applications, exactness in query results is frequently less important. In many cases, “ballpark estimates” are adequate to provide the desired insights about the data, at least in preliminary phases of analysis. For example, knowing the marginal data distributions for each attribute up to 10% error will often be enough to identify top-selling products in a sales database or to determine the best attribute to use as a root of a decision tree.

The acceptability of inexact query answers coupled with the necessity for fast query response times has led researchers to investigate approximate query processing (AQP) techniques that sacrifice accuracy to improve running time, typically through some sort of lossy data compression. A printed publication known as The New Jersey Data Reduction Report discusses many of the techniques that have been tried. The general rubric in which most approximate query processing systems operate is as follows: first, during a “preprocessing phase”. some auxiliary data structures are built over the database; then, during the “runtime phase”, queries are issued to the system and approximate query answers are quickly returned using the data structures built during the preprocessing phase. The requirement for fast answers during the runtime phase means that scanning a large amount of data to answer a query is not possible, or else the running time would be unacceptably large. Thus, most approximate query processing schemes have restricted themselves to building only small auxiliary data structures such as a small sample of the data (e.g. a random subset of rows of the original database table).

Some prior art methods for addressing the long run times of data analysis queries are not approximate query processing (AQP) techniques at all, but rather OLAP query processing techniques designed to more efficiently produce exact answers to analysis queries. Examples of this class of techniques include constructing materialized views of “data cubes” over commonly-queried attributes and building indexes targeted at analysis queries. These physical data design techniques typically make use of significant preprocessing time and space and can be quite effective at speeding up specific queries, particularly when the query workload is known in advance and can be leveraged during preprocessing. However, since it is prohibitively expensive to build indexes or materialized views sufficient to cover all possible queries, such techniques are of limited value for answering ad hoc analysis queries; inevitably there will be certain unanticipated queries that “fall through the cracks” and are not aided by physical design, particularly in exploratory data mining and decision support applications. Therefore application of physical database design technology does not eliminate the need for AQP technology; rather, the two are complementary.

The area of approximate answering of aggregate queries has been the subject of prior art analysis. Hellerstein et al. (Proc.1997 ACM SIGMOD (pages 171-182) and Proc 2002 ACM SIGMOD (pages 275-286)) describe techniques for online aggregation in which approximate answers for queries are produced during early stages of query processing and gradually refined until all the data has been processed. The online aggregation approach has some compelling advantages. For example, it does not require preprocessing, and it allows progressive refinement of approximate answers at runtime. However, there are two important systems considerations that represent practical obstacles to the integration of online aggregation into conventional database systems. First, stored relations are frequently clustered by some attribute, so accessing tuples in a random order as required for online aggregation requires (slow) random disk accesses. Second, online aggregation necessitates significant changes to the query processor of the database system.

Due to the difficulty of purely online approaches to AQP, other research has focused on systems that make use of data structures built by preprocessing the database. Sophisticated data structures such as wavelets and histograms have been proposed as useful tools for AQP. Work in these areas is of great theoretical interest, but as with online aggregation, its practical impact is often limited by the extensive modifications to query processors and query optimizers that are often needed to make use of these technologies. Partly for this reason, sampling-based systems have in recent years been the most heavily studied type of AQP system. Sampling-based systems have the advantage that they can be implemented as a thin layer of middleware which re-writes queries to run against sample tables stored as ordinary relations in a standard, off-the-shelf database server.

The AQUA project at Bell Labs is reported in three papers (A fast decision support system using approximate query answers In Proc. 1999 Intl. Conf on Very Large Data Bases, pages 754-755, September 1999, Congressional samples for approximate answering of group-by queries. In Proc 2000 ACM SIGMOD pages 487-498, May 2000, and Join synopses for approximate query answering. In Proc 1999 ACM SIGMOD, pages 275-286, June 1999) that describe a sampling-based system for approximate query answering. Techniques used in AQUA included join synopses, which allow approximate answers to be provided for certain types of join queries, and congressional sampling. The problem of sampling-based approximate answers for join queries was also addressed in a paper to Chaudhuri et al entitled “On Random Sampling Over Joins” In Proc 19999 ACM SIGMOD, pages 263-274, June 1999, which includes several strong negative results showing that many join queries are unfeasible to approximate using un-weighted sampling.

Besides congressional sampling, several other weighted sampling techniques have been proposed that outperform uniform random sampling for certain types of queries. The use of workload information to construct biased samples to optimize performance on queries drawn from a known workload has been considered in a paper to Chaudhuri entitled “A Robust, Optimization-Based Approach for Approximate Answering of Aggregate Queries. In Proc 2001 ACM SIGMOD, pages 295-306, May 2001. Workload information has also been used (Ganti et al Self-tuning samples for approximate query answering In Proc 2000 Intl. Conf on Very Large Data Bases, pages 176-187, Sept 2000) to construct “self-tuning” biased samples that adapt to the query workload. A paper to Chaudhuri et al entitled “Overcoming limitations of sampling for aggregation queries” In Proc 2001 Intl. Conf. On Data Engineering 2001 proposes a technique called outlier indexing for improving sampling-based approximations for aggregate queries when the attribute that is being aggregated has a skewed distribution. This process augments ordinary uniform random samples with a small number of carefully chosen additional tuples from the database.

The sample selection architecture proposed in this paper is dynamic in the sense that the sample used to answer a particular query is assembled dynamically at the time that the query is issued, rather than using a static, pre-computed sample. This is in contrast to two other classes of techniques that are sometimes termed “dynamic” in the literature: incremental maintenance techniques that efficiently update data structures in response to changes in data, and adaptive query execution strategies that modify execution plans for long-running queries in response to changing conditions.

Relatively large running times and space usage during the preprocessing phase are generally acceptable as long as the time and space consumed are not exorbitant. For this reason, it is possible to scan or store significantly larger amounts of data during pre-processing than it is feasible to access at runtime. Since the query process is only able to access a small amount of stored data at runtime, there is no gain to be had from building large auxiliary data structures unless they are accompanied by some indexing technique that allows the query processor to decide, for a given query, which (small) portion of the data structures should be accessed to produce the most accurate approximate query answer.

### SUMMARY OF THE INVENTION

The disclosed system concerns a database architecture for approximate query processing that is based on dynamic sample selection. During a preprocessing phase a large number of differently biased samples are constructed. For each query that arrives during the runtime phase, a query processor dynamically selects an appropriate small subset from the samples that can be used to give a highly accurate approximate answer to the query.

An advantage of dynamic sample selection stems from the observation that, for most queries, an appropriately biased sample can produce more accurate approximate answers than a uniform sample. Previous attempts to exploit this observation via non-uniform sampling sample using a bias that is carefully chosen with the intent to provide good accuracy across a particular set of queries. However, what constitutes an “appropriate” bias can be quite different from one query to the next, so no single biased sample can be effective for all queries.

Unlike previous techniques which relied on a single sample with a fixed bias, dynamic sample selection constructs an individually tailored sample for each query in a semi-online fashion: the creation of the sub-samples used as building blocks is performed off-line but their assembly into an overall sample is done online.

The theory behind dynamic sample selection is to accept greater storage (typically disk) usage for summary structures than other sampling-based AQP methods in order to increase accuracy in query responses while holding query response time to a reasonable level (or alternatively, to reduce query response time while holding accuracy constant). We believe that for many AQP applications, response time and accuracy are more important considerations than disk usage. For these applications, the tradeoff chosen by dynamic sample selection is the right one.

An additional feature of the system is the development of a particular instantiation of dynamic sample selection referred to as small group sampling. Small group sampling is designed to answer a standard class of analysis queries, aggregation queries with “group-bys”. The discussion below relating to an exemplary embodiment includes explanation of the small group sampling process.

Results on test data demonstrate that small group sampling outperforms previously known approximate query processing techniques. A more thorough understanding of the system is obtained by reviewing the accompanying explanation of an exemplary embodiment of the invention in conjunction with the accompanying drawings.

### BRIEF DESCRIPTION OF THE DRAWINGS

FIG. 1 is an overview of an exemplary computer system for practicing the present invention;

FIGS. 2 and 3 depict a dynamic sample selection architecture for approximate query processing;

FIG. 4 is a schematic representation of a large database showing records stored in the database;

FIG. 5 is a two dimension depiction showing data contained within the HOMES database showing a data distribution categorized in accordance with two data attributes; and

FIGS. 6A and 6B depict results of analytical simulations of small group sampling.

### EXEMPLARY MODE FOR PRACTICING THE INVENTION

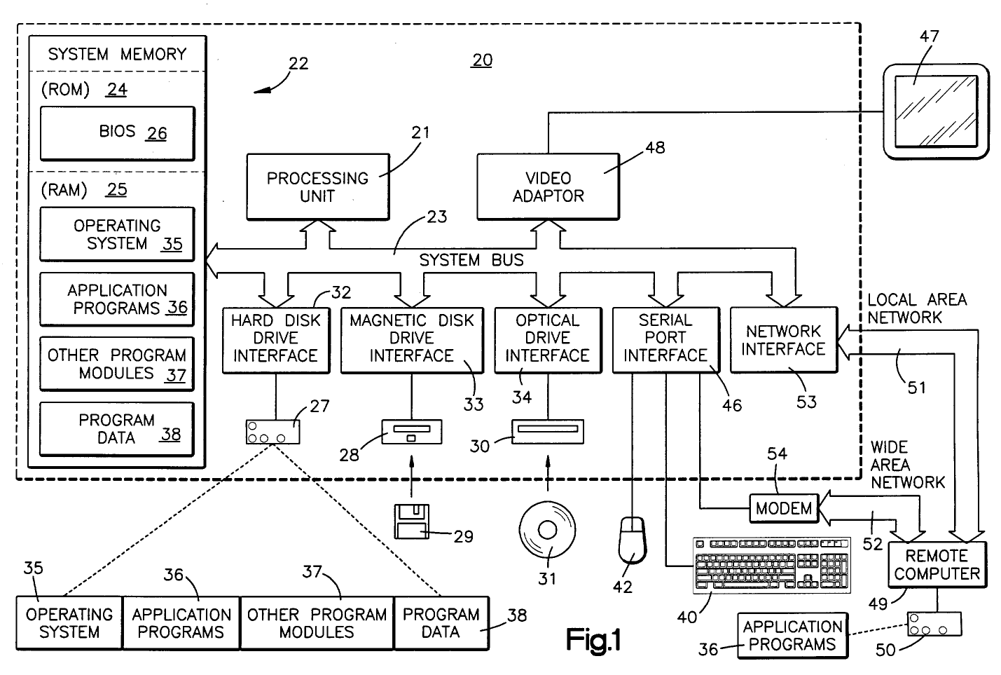

FIG. 1 depicts an exemplary data processing system for practicing the disclosed invention utilizing a general purpose computer 20. A data mining software component that executes on the computer 20 accesses a database to extract data records stored within that database. An application program 36 either executing on the computer 20 or in communications with the computer 20 by means of a communications link such as a network 51 makes requests of a data mining program that forms one of the ‘other program modules’ 37.

As seen by referring to FIG. 1 the computer 20 includes one or more processing units 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures.

The system memory includes read only memory (ROM) 24 and random access memory (RAM) 25. A basic input/output system 26 (BIOS), containing the basic routines that help to transfer information between elements within the computer 20, such as during start-up, is stored in ROM 24.

The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAM), read only memories (ROM), and the like, may also be used in the exemplary operating environment.

A number of program modules including the data mining software component may be stored on the hard disk, magnetic disk 29, optical disk 31, ROM 24 or RAM 25, including an operating system 35, one or more application programs 36, other program modules 37, and program data 38. A user may enter commands and information into the computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. In addition to the monitor, personal computers typically include other peripheral output devices (not shown), such as speakers and printers.

The computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the computer 20 is connected to the local network 51 through a network interface or adapter 53. When used in a WAN networking environment, the computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in a remote memory storage device. It will be appreciated that the network connections shown are exemplary and other means of establishing a communications link between the computers 20, 49 may be used.

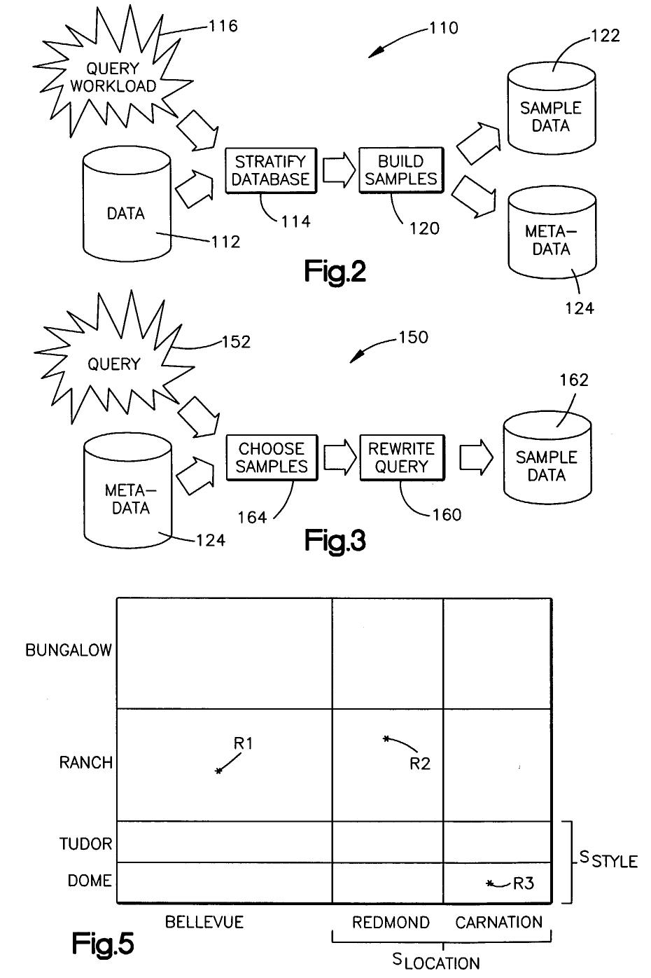

FIGS. 2 and 3 depict a dynamic sample selection architecture for approximate query processing. Standard sampling-based AQP strategies are not able to take advantage of extra disk space when it is available because increasing the size of a sample stored on disk increases the running time of a query executing against that sample. Dynamic sample selection gets around this problem by creating a large sample containing a family of differently biased sub-samples during a preprocessing phase but only using a small portion of the sample to answer each query at runtime. Because there are many different sub-samples with different biases available to choose from at runtime, the chances increase that one of them will be a “good fit” for any particular query that is issued. Because only a small portion of the overall sample is used in answering any given query, however, the query response time is kept low.

To see why biased sampling is useful, consider the following example:

### EXAMPLE 1

### Consider a Database Consisting of 90 Tuples With Product=‘Stereo’ and 10 Tuples With Product=‘TV’.

Compare two different ways of selecting a ten-tuple random sample:

1. Select 10% of the tuples uniformly, each with weight 10.

2. Select 0% of the Product=‘Stereo’ tuples and 100% of the Product=‘TV’ Tuples, and give each TV tuple weight 1.

The weight of a tuple is the inverse of the sampling rate that was used for the partition of the database from which that tuple was drawn. To answer a count query using a sample, one scales each sample tuple by its weight.

Consider the query asking for the count of tuples where Product is TV. The second sample will always give the exact answer. The first sample will give the right answer only if exactly one of the TV tuples was chosen for the sample; this occurs only with probability 0.41, so that with probability 0.59, the estimate is off by at least a factor of two.

As example 1 shows, when portions of the database that are more heavily represented in a biased sample match with the portions of the database that are selected in a query, that sample will give a better estimate for that query than a sample where the reverse is true. Other factors can also cause a biased sample to be a “good fit” for a query. For example, when a measure attribute being summed has a skewed data distribution, more accurate approximate answers can be obtained by allocating a disproportionately large sample share to outlier values of the distribution.

Pre-Processing Phase

FIG. 2 depicts a preprocessing phase 110 in a dynamic sample selection architecture. The preprocessing phase 110 proceeds in two steps. In the first step, ‘the data distribution of the data 112 in a database is examined to identify a set of biased samples to be created. The result of this step is a division or stratification 114 of the database into (possibly overlapping) strata. If reliable query distribution information is available (e.g. a query workload 116), it can also be taken into account in this step. In the second step, the samples are built 120 (potentially using a different sampling rate for each stratum) and stored in the database as sample data 122 along with metadata 124 that identifies the characteristics of each sample.

Runtime Phase

FIG. 3 depicts a runtime phase 150. When a query 152 or queries are issued at runtime, the dynamic sample selection system rewrites 160 the queries to run against sample tables rather than the original base tables referenced in the queries. The appropriate sample table(s) 162 to use for a given query Q are determined by comparing Q with the metadata 124 annotations for the samples choosing 164 the appropriate sample table or tables. Based on the query, the sample table or tables 162 is a subset of the totality of the sample tables 122 that were created during the preprocessing phase 110 of analysis. Methods for building samples during preprocessing are well know. Methods for accessing those samples at runtime that are based on query optimization technology are also well known in the art.

Policies for Sample Selection

For dynamic sample selection to be successful, the samples that are created must be chosen in such a way that, when given a query, it is possible to quickly determine which of the various samples to use to answer that query. A straightforward dynamic sample selection strategy is one where the choice of samples is guided by the syntax of the incoming query. Some simple syntactic properties of queries have been used for sample selection in previous work. Separate samples are created for each table in a database and the appropriate sample is chosen based on the table(s) referenced in the query's FROM clause. In other work, a separate sample is created for use with each of a pre specified list of aggregate expressions and the appropriate sample is chosen based on the aggregate expression in the query's SELECT clause.

A powerful application of query syntax-based dynamic sample selection is referred to as small group sampling. In small group sampling, the sample tuples that are used for a query Q are determined by the grouping attributes from the query Q. The disclosure focuses on small group sampling because it targets the most common type of analysis queries, aggregation queries with “group-bys”. It also exemplifies the flexibility of dynamic sample selection because it selects from a large space of overlapping subsets of the pre-computed sample when answering queries. In contrast, previous syntax-based schemes merely choose from a small number of non-overlapping partitions of the pre-computed sample.

In principle, more complex policies for dynamic sample selection are possible that utilize information in addition to the query syntax. For example, in a workload-based AQP scheme, multiple samples may be created for work-loads that differ from one another in characteristics that are not captured in syntax, e.g., overlap in the set of tuples accessed. In such a case, the choice of an appropriate sample for an incoming query may be determined by its relative “distance” from the samples for different workloads. Such distance computation can be based on analysis of query execution plans and workload-compression techniques discussed in. Such techniques are likely to have higher overhead than syntax-based dynamic sample selection and will be studied in future work.

Small Group Sampling

Small group sampling is a specific dynamic sample selection technique that is designed for answering a common and useful class of queries: aggregation queries with “groupbys”, the prototypical OLAP queries. The small group sampling technique is described in detail, and then analytical justification for the technique is provided.

Certain assumptions are made. It is assumed that (1) the queries are against a single fact table without any joins or (2) the queries are over a “star schema” where a fact table is joined to a number of dimension tables using foreign-key joins. Arbitrary joins are not considered. However, foreign-key joins represent the majority of joins in actual data analysis applications, so this restriction is not unduly limiting.

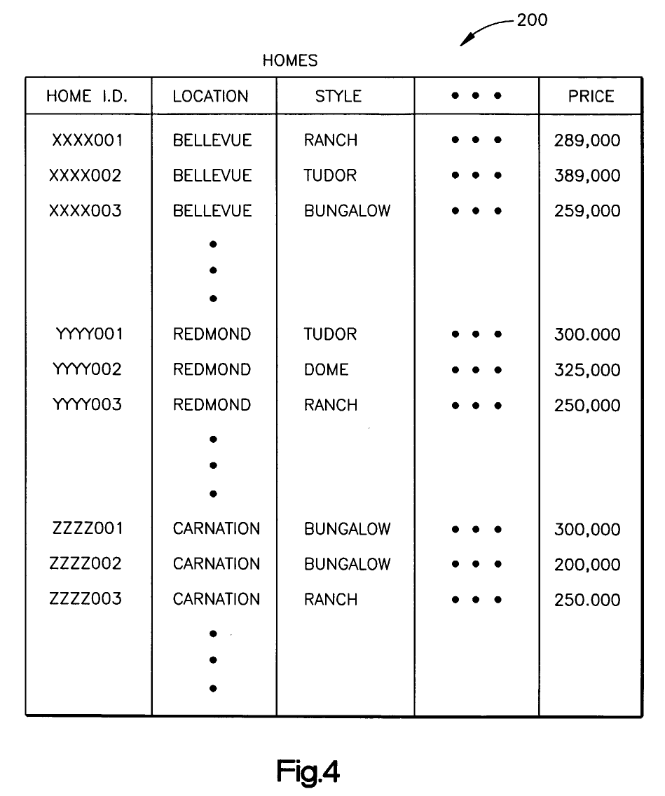

Consider the HOMES table 200 depicted in FIG. 4. This table contains a listing of home type or style, location and price for a database containing many records. Other so called attribute have been deleted but could include for example owner's name, date of construction, square footage etc. Although the locations listed are for one metropolitan area, the location attribute could include homes from the entire country or even include homes in foreign countries. The HOMES table could include many millions of records each having a record ID (Home I.D.) and multiple attributes contained in either one table or linked through foreign keys to multiple tables. Features of the invention are discussed in conjunction with the HOMES table.

Motivation for Small Group Sampling

One of the shortcomings of uniform random sampling for answering group-by queries is that uniform samples give weight to each group in proportion to the number of tuples falling into that group. When the distribution of the sizes (measured in number of tuples) of the groups in the query is skewed, as is frequently the case in practice, this results in over-sampling of some groups and under-sampling of others. In contrast, the most accurate approximate answers to a group-by query are given when sample space is divided as equally as possible among the groups in the query.

Unfortunately, the number of possible group-by aggregation queries is immense, so achieving the ideal sample allocation for each query by creating a separate sample per query is infeasible. Instead, what is required is some heuristic for choosing a set of samples that does a reasonable job on most group-by queries. One prior art paper suggest a process known as congressional sampling. The basic idea behind congressional sampling is to consider the set of all possible group-by queries without any selection conditions and to calculate for each tuple t and each query Q the probability p(t, Q) with which the tuple should be included in the optimal biased sample for Q, assuming some fixed sample size. Each tuple t is assigned a weight equal to max_{Qεg}p(t, Q) and a single stratified sample is constructed that includes each tuple with probability proportional to its weight. In essence, congressional sampling attempts to build a single sample that balances between all possible combinations of grouping columns.

In accordance with the exemplary system an alternate small group sampling process is implemented that improves on two shortcomings of congressional sampling. The first shortcoming is that since congressional sampling only creates a single sample, that sample must necessarily be very general-purpose in nature and only loosely appropriate for any particular query. The present system uses the dynamic sample selection architecture of FIGS. 2 and 3 and realizes a benefit of more specialized samples that are each tuned for a narrower, more specific class of queries. A second shortcoming of congressional sampling is that the preprocessing time required is proportional to the number of different combinations of grouping columns, which is exponential in the number of columns. This renders it impractical for typical data warehouses that have dozens or hundreds of potential grouping columns. In contrast, the preprocessing time for the exemplary small group sampling is linear in the number of columns in the database.

The intuition behind small group sampling is that uniform sampling does a satisfactory job at providing good estimates for the larger groups in a group-by query since those groups will be well represented in the sample. It is the small groups that are the problem case for uniform sampling; however, precisely because the groups are small, it would not be excessively expensive to actually scan all the records contributing to small groups, assuming that we could identify them. The small group sampling approach uses a combination of a uniform random sample, which we call the overall sample, that provides estimates for large groups and one or more “sample” tables, which we call small group tables, that contain only rows from small groups. The small group tables are not downsampled—100% of the rows from the small groups are included to ensure that the aggregate values for these groups can be given with complete accuracy.

The rows that fall into groups that are small will depend on the query that is asked. The set of groups in the query answer and their sizes depend on the grouping columns and the selection predicates of the query. The small group sampling heuristic builds tables containing the small groups from a specific set of aggregation queries: queries with a single grouping column and no selection predicates. Each query's small groups are stored in a different table. This set of queries was chosen for several reasons:

It is of manageable size, linear in the number of columns in the database.

Determining which sample tables to use for any query is straightforward: besides the overall sample, the small groups tables for each grouping column in the query Q are queried, and a final approximate answer is composed out of the results of these queries.

The tuples from small groups in a query that groups on a single column C and has no selection predicates will also be in small groups in all other queries (in the class that we consider) that include C in their group-by list.’ Therefore the small group tables we build using single column group-by queries without predicates will be broadly applicable to other group-by queries. Note, ‘For COUNT and SUM, the aggregation functions, “smallness” is a monotonic condition in the number of grouping columns and in the number of selection predicates, meaning that if a group g is small in some query Q, then it remains small even if Q is modified by adding more grouping columns or additional selection predicates.

Description of Small Group Sampling

The preprocessing algorithm for small group sampling takes two input parameters, the base sampling rate r, which determines the size of the uniform random sample that is created (i.e., the overall sample), and the small group fraction t, which determines the maximum size of each small group sample table. The parameters r and t are expressed as fractions of the total database size. “The database” means either the single fact table (for the single table schema) or the view resulting from joining the fact table to the dimension tables (for the star schema). The HOMES database depicted in FIG. 4 could represent either such a database.

Denote by N the number of rows (or tuples or records) in the database and denote by C the set of columns in the database. The preprocessing produces three outputs: (a) an overall sample table with Nr rows; (b) a set of small group tables, one for each column in some set S contained in C where S is determined by the process, with at most Nt rows in each table in S; and (c) a metadata table that lists the members of S and assigns a numeric index to each one. Such preprocessing can be implemented quite efficiently by making just two scans of the database.

The first scan identifies the frequently occurring values for each column and their approximate frequencies. In the second scan, the small group tables for each column in S are constructed, along with the overall sample. The first scan may be omitted if sufficient information is already available in the database metadata, e.g. as histograms built for a query optimizer.

Initially, the set S is initialized to C. In the first pass over the data, the small group process counts the number of occurrences of each distinct value in each column of the database in order to determine the common values for each column. This can be done using a separate hashtable for each column. For columns or attributes that have very large numbers of distinct values, the memory required to maintain such a hashtable could grow rather large. However, such columns are unlikely candidates to be grouping columns in the type of analysis queries that would be targeted at an AQP system, and furthermore small group sampling is not likely to be an effective strategy for such columns. Therefore, once the number of distinct values for a column exceeds a threshold T (which was set to 5000 in testing of the process), that column is removed from S and the process ceases to maintain its counts. The memory required to maintain the hashtable of counts for each column is thus quite small. Since typical database columns have even fewer distinct values (e.g. dozens), the total memory required to simultaneously maintain the hashtables of all database columns is relatively modest.

After the first pass, the process determines the set of common values L(C) for each column C. L(C) is defined as the minimum set of values from C whose frequencies sum to at least N(1-t), and it is easily constructed by sorting the distinct values from C by frequency.

Rows with values from the set L(C) will not be included in the small group table for C, but rows with all other values will be; there are at most Nt such rows. It may be that a column C has no small groups, in which case it is removed from S. After computing L(C) for every C contained in S, the algorithm creates a metadata table which contains a mapping from each column name to an unique index between 0 and |S|-1.

FIG. 4 depicts a table 200 of example data relating to homes in different geographic regions. The two attributes or columns from this table that are likely candidates for small group sampling are the ‘location’ and the ‘style’ attributes. The price attribute is likely to have many distinct values. Assume a database having 10⁶ or one million records so N equals one million. If the base group sampling rate r is chosen to be 1% and t, the small group fraction is chosen to be one half that size, then N(t) is equal to 5000 and hence N(1-t) is 995,000. Consider the location attribute. Bellevue is a large region having a large number of homes. There are over five thousand homes in this region alone. However let us assume that the sum total of the homes in Carnation and Redmond are less than 5000. This means that homes in these two regions would be candidates for inclusion into a small group sample of a table designated as S_{location}.

A final step in preprocessing is to make a second scan of the database to construct the sample tables. Each row containing an uncommon value for one or more columns (i.e. a value not in the set L(C)) is added to the small group sample table for the appropriate columns. At the same time as the small group tables are being constructed, the preprocessing algorithm also creates the overall sample, using reservoir sampling to maintain a uniform random sample of rN tuples. Each row that is added to either a small group table or the overall sample is tagged with an extra bit-mask field (of length |S|) indicating the set of small group tables to which that row was added. This field is used during runtime query processing to avoid double counting rows that are assigned to multiple sample tables.

Returning to the example from FIG. 4, since the location attribute has values whose total number of records is less than the cutoff of 5000 a small group table for that attribute is created. Assume only Redmond and Carnation fall within this category. This would result in the second phase of the preprocessing to create a table S_{location} which contained all records from the HOMES table that contain either a record of a home in Redmond or a record corresponding to a home in Carnation. Additionally, a second sample table Sₒᵥₑᵣₐₗₗ is created which is a one percent sampling of the database table HOMES.

Although the overall sample Sₒᵥₑᵣₐₗₗ is described in the preceding paragraph as being a uniform random sample, it is also possible to use a non-uniform sampling technique to construct the overall sample; for example, an outlier indexing process could be used to construct the overall sample. In this respect, the small group sampling technique is orthogonal to other weighted sampling techniques and can be used in conjunction with them. Unless explicitly stated it is assumed the term “small group sampling” refers to small group sampling with a uniform overall sample unless explicitly stated otherwise. For example the aforementioned variant would be referred to as “small group sampling enhanced with outlier indexing”.

When a query arrives at runtime, it is re-written to run against the sample tables S_{location} (and others) and Sₒᵥₑᵣₐₗₗ instead of the base fact table, HOMES. Each query is executed against the overall sample, scaling the aggregate values by the inverse of the sampling rate r. In addition, for each column C contained in S in the query's group-by list, the query is executed against that column's small group table. The aggregate values are unsealed when executing against the small group sample tables since those tables contain 100% of the records having a specified value for the attributes. Finally, the results from the various sample queries are aggregated together into a single approximate query answer.

Since a row can be included in multiple sample tables, the rewritten queries include filters that avoid double-counting rows. Consider the depiction in FIG. 5. This is a depiction in two dimensions of records from the HOMES table for the two attributes ‘style’ and ‘location’. Consider a record R1 representing a home in Bellevue having a ranch style. This record falls in neither S_{location} nor S_{style} due to the fact that ranch style homes and home in Bellevue occur with too great a frequency in the HOMES database table. Now consider a ranch style home in Redmond. This record R2 is copied into the S_{location} database table. If it is also in the Sₒᵥₑᵣₐₗₗ table, then steps must be taken to assure the record is not double counted. Consider the record corresponding to a home located in Carnation having a dome style construction. This record is copied to both S_{location} and S_{style} and could also be contained in Sₒᵥₑᵣₐₗₗ.

When the query is rewritten 160 to run against a first small group table, no additional filtering is applied. When running against the second small group table, rows that were already included in the first small group table are filtered out, and so on. The rows to be filtered can be efficiently identified by applying an appropriate mask to the bitmask field that is appended onto all records in all sample tables. For example, consider the following single table database query: SELECT location, style, COUNT(s) AS cnt FROM HOMES GROUP BY location, style. Assume that small group preprocessing has been completed with a base sampling rate of 1%, and that small group tables exist for both column ‘location’ and column ‘style’, and that these columns are assigned the indexes 0 and 2, respectively. Then the rewritten query looks like:

SELECT location, style, COUNT(s) AS cnt FROM S_{location}

GROUP BY location, style

UNION ALL

SELECT location, style, COUNT(S) AS cnt FROM S_{style}

WHERE bitmask & 1=0

GROUP BY location, style

UNION ALL

SELECT location, style, COUNT(S)*100 AS cnt

FROM Sₒᵥₑᵣₐₗₗ

WHERE bitmask & 5=0/Since 5=2°+2²*/

GROUP BY location, style

To aid the user in interpreting the reliability of the approximate query answer, the system can provide confidence intervals (not shown in above example) for each aggregate value in the query answer. Answers for groups that result from querying small group tables are marked as being exact, and confidence intervals for the other groups are provided using standard statistical methods, e.g. Note that confidence interval calculation is very simple when using small group sampling because the source of inaccuracy can be restricted to a single stratum. In contrast, other stratified sampling techniques need to perform complex calculations involving the sampling rates for various strata to provide accurate confidence intervals.

Alternate Embodiments

The small group sampling technique admits several variations and extensions beyond the basic process described above. As an alternative to using single-column group-by queries, one could generate small group tables based on selected group-by queries over pairs of columns, or based on other more complex queries. The number of pairs of columns for an m-column database is m(m−1)/2, however, so some judgment would have to be exercised in selecting a small subset of pairs when m is large. Query workload information could also be used to trim the set of columns for which small group tables are built by identifying rarely queried columns.

Small group sampling creates a two-level hierarchy: small groups are sampled at a 100% rate, while large groups are sampled at the base sampling rate. This approach could be extended to a multi-level hierarchy. For example, one could sample 100% of rows from small groups, 10% of rows from “medium-sized” groups, and 1% of rows from large groups.

More sophistication could be added to the runtime selection of which small group samples to use. For example, for queries with a large number of grouping columns, using all relevant small group tables might result in unacceptably large query execution times; in this case, a heuristic for picking a subset of the relevant small group tables to query could improve performance.

Accuracy Metrics

When evaluating small group sampling, two different accuracy criteria for approximate answers to group-by queries should be considered. First, as many of the groups as possible that are present in the exact answer should be preserved in the approximate answer. Second, the error in the aggregate value for each group should be small. In order to formalize these accuracy criteria as measurable error metrics, some notation is required.

Given an aggregation query Q, let G={gₗ . . . gₙ} be the set of n groups in the answer to Q, and let xᵢ denote the aggregate value for the group gᵢ. In the special case where Q is a simple aggregation without grouping, n=1. Consider an approximate answer A for Q consisting of a set of m groups G′={gᵢ_{ₗ} . . . gᵢ_{ₙ}} with aggregate values x′ᵢ₁ . . . x′ᵢₘ. Since we are concerned in this paper with sampling-based estimators, which never introduce spurious groups into the answer, we assume that G′ is contained within G.

Definition 1:

The percentage of groups from Q missed by A is defined as

$$PctGroups ( Q , A ) = \frac{n - m}{n} \times 100$$

Definition 2:

The average relative error on Q of A is defined as:

$$RelErr ( Q , A ) = \frac{1}{n} ( ( n - m ) + {\sum }_{j = 1}^{m} \frac{\vert {X}_{{i}_{j}} - {X}_{{i}_{j}} \vert}{{X}_{{i}_{j}}} )$$

In other words, to compute the average relative error on Q of A, take the average relative error in the aggregate value, averaging across the groups in the exact answer and taking the relative error for each of the n-m groups omitted from the approximate answer A to be 100%.

For analytical convenience, define one additional metric, SqRelErr(Q,A), the average squared relative error on Q of A. SqRelErr is used in place of RelErr in analytical comparisons of uniform random sampling with small group sampling because it measures the same general objective (errors in aggregate values should be small for all groups) and is much more analytically tractable.

Definition 3. The average squared relative error on Q of Q is defined as:

$$Sq RelErr ( Q , A ) = \frac{1}{n} ( ( n - m ) + {\sum }_{j = 1}^{m} {( \frac{{x}_{{i}_{j}} - {x}_{{i}_{j}}^{′}}{{x}_{{i}_{j}}} )}^{2} )$$

Analysis

To quantify the benefits that one might expect to achieve from small group sampling, conduct an analytical comparison of the expected performance of small group sampling and uniform random sampling on count queries over an idealized database. For analytical convenience use the SqRelErr metric instead of the RelErr metric Also make the simplifying assumption that Bernoulli sampling is performed, so each tuple is independently included in the sample with probability p. (In actuality, a fixed size sample is produced that has a p fraction of the overall rows.)

First derive equations for SqRelErr for uniform random sampling and small group sampling. Given a count query Q over a database with N tuples, let G={gₗ . . . gₙ} be the set of n groups in the answer, and let pi denote the fraction of N tuples that belong to group gi. Let C denote the set of grouping columns in the query Q and let [v_{C,gi}εL(C)] denote the indicator function that equals 1 when the value for grouping column C in group Gi is one of the common values L(C) and zero otherwise. Consider Aᵤ, an approximate answer for Q produced using uniform random sampling at sampling rate s/N, and A_{sg}, an approximate answer for Q produced using small group sampling with an overall sample generated at sampling rate s′/N. Let Eᵤ=E[SqRelErr(Q, Aᵤ)] and Esg=E[SqRelErr(Q,A_{sg})] denote the expected values of the average squared relative error on Q of Aᵤ and of A_{sg}, respectively.

$$\begin{matrix}{E}_{u} = \frac{1}{sn} {\sum }_{{g}_{i} ∈ G} \frac{1 - {p}_{i}}{{p}_{i}} & eq 1 \\ {E}_{sg} = \frac{1}{{s}^{′} n} {\sum }_{{g}_{i} ∈ G} ( \frac{1 - {p}_{i}}{{p}_{i}} {\prod }_{C ∈ G} [ {v}_{C , {g}_{i}} ∈ L ( C ) ] ) & e q 2\end{matrix}$$

Proof:

Consider a particular group gᵢ in the answer to Q. If a uniform random sample S is created by including each tuple with probability s/N, then the number of tuples Sᵢ from group gᵢ that are included in the sample will be binomially distributed with mean spᵢ and variance spᵢ(1-pᵢ). To estimate the number of tuples in group gᵢ using the sample S, scale Sᵢ by the inverse sampling rate N/s. The resultant random variable has mean Npᵢ and variance N²pᵢ(1-pᵢ)/s. The squared relative error is equal to the squared error divided by the square of the actual group count Npᵢ, and the expected squared error is just the variance, so the expected squared relative error in the estimate of the count for group gᵢ is equal to

$$\frac{1 - {p}_{i}}{{sp}_{i}} .$$

To compute Eᵤ, then, take the average of spin

$$\frac{1 - {p}_{i}}{{sp}_{i}}$$

over all groups giεG, giving equation 1.

When small group sampling is used, for those groups that are captured by the small group sample tables, there will be no error whatsoever because no downsampling is performed when constructing these tables. For all other groups, the expected squared relative error will be

$$\frac{1 - {p}_{i}}{{s}^{′} {p}_{i}} .$$

Averaging Over All Groups Yields Equation 2.

To ensure a fair comparison between different AQP systems, allow each system to use the same amount of sample space per query at runtime. If small group sampling and uniform random sampling are both allowed to query s sample rows at runtime, then the size s′ of the overall sample queried by small group sampling will be less than s since some of the s rows will come from small group tables. Small group sampling will be perfectly accurate on the groups covered by small group tables, but since s′<s, small group sampling will make somewhat larger errors than uniform random sampling on the other groups. Whether small group sampling will be preferable to uniform random sampling depends on whether its precise accuracy on small groups compensates for its increased error on large groups.

The values of Eᵤ and E_{sg} depend on the data distribution, the queries, and the allocation of available sample space between the overall sample and the small group tables. In order to understand when small group sampling excels and when it does poorly, we applied Equations 1 and 2 to a number of different query scenarios. Because Equations 1 and 2 are not in closed form, the summations are computed using a computer program and plotted graphically.

It is assumed that attributes are distributed according to a truncated Zipfian distribution, i.e. the frequency of the ith most common value for an attribute is proportional to i^{-z} for some constant z (called the skew parameter), except that the frequency is 0 if i>c for some constant c that regulates the number of distinct attribute values. Also assume for simplicity that the attributes are independent of one another. To analyze the effects of varying data distribution, different values for z and c were tried. To understand the effects of varying types of queries, different numbers were considered for grouping columns g and selection predicates selectivities σ assuming that a predicate of selectivity σ includes each tuple independently with probability σ. Also vary the sampling allocation ratio γ=t/r. (Recall that t and r control the sizes of each small group table and the overall sample, respectively.)

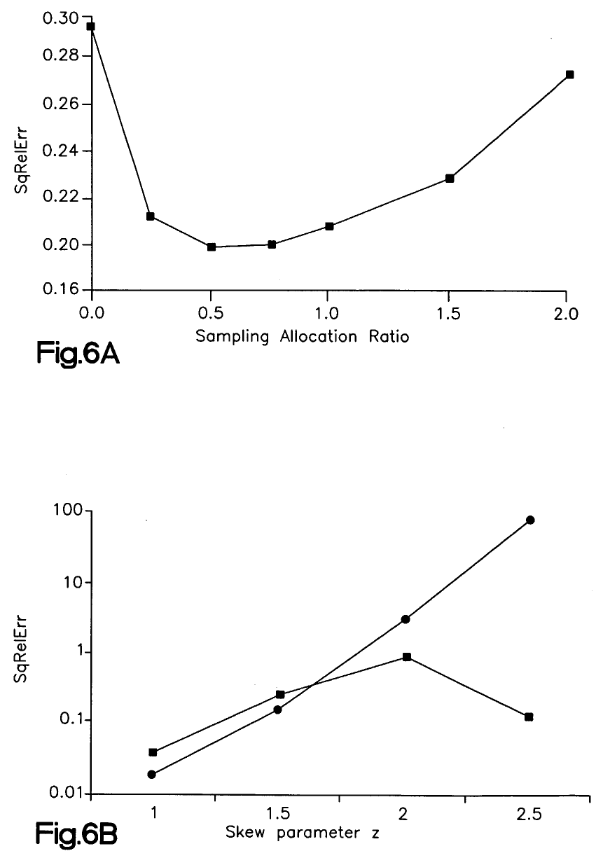

The testing seeks an answer to the question (1) what is the optimal relationship between the small group sampling's input parameters t and r and (2) what is the relative performance of small group, sampling and uniform random sampling under various circumstances? The results of analytic simulations are shown in FIGS. 6A and 6B.

FIG. 6A shows the effect of various choices for the sampling allocation ratio. Uniform random sampling is equivalent to small group sampling with a sampling allocation ratio of zero.

The analysis suggests that a sampling allocation ratio of 0.5 performs well across a wide range of data distributions. (The results in FIG. 6A are for g=2, σ=0.1, c=50, and z=1.8) A sampling allocation ratio of 0.5 means that the maximum size for a small group sample table is half the sizes of the uniform random sample. As can be seen from FIG. 6A however, the exact choice of the sampling allocation ratio is not critical, as values from 0.25 to 1.0 had similar results.

FIG. 6B compares the performance of small group sampling (square data points) with uniform sampling (round data points) across a range of values for the skew parameter z. It was found that the query selectivity, number of grouping columns, and the number of distinct values did not have a significant impact on the relative performance of the two strategies. This figure uses g=3, θ=0.3, c=50 and γ=0.5. It was found that uniform sampling is slightly preferable to small group sampling for data that is uniformly distributed or very nearly so. For data distributions with moderate to high skew, small group sampling was clearly superior to uniform sampling.

The analytical model is based on a number of simplifying assumptions that are unlikely to hold in real applications but the results of the analysis provide reason to believe that small group sampling is effective.

Test Results

The exemplary embodiment was tested and compared against the prior art for multiple databases having a star schema. For COUNT queries, the accuracy of small group sampling is better than uniform random sampling and congressional sampling. For COUNT queries, the accuracy of all methods degrade with (a) increasing number of grouping columns referenced in the query, (b) decreasing average group size of the query result, and (c) decreasing data skew. However, the degradation is less pronounced for small group sampling compared to uniform random sampling and basic congress. For SUM queries, the accuracy of small group sampling (enhanced with outlier indexing techniques) is better than outlier indexing techniques alone.

The query processing times of all AQP processes are comparable to each other and orders of magnitude faster than executing the exact query over the entire database. Small group sampling requires more space to store sample tables than the other prior art systems. However, (a) unlike the other systems, small group sampling can take advantage of extra available space and (b) the extra space is an acceptably small fraction of the space consumed by the original database tables. Small group sampling has acceptable pre-processing time, it is slower than uniform random sampling and outlier indexing, but comparable to basic congress. Detailed results from testing are found in a paper entitled “Dynamic Sample Selection for Approximate Query Processing” published in proceedings of SIGMOD conference June 2003 and which is incorporated herein by reference.

While the present invention has been described with a degree of particularity, it is the intent that the invention include all modifications and alternations from the disclosed design falling within the spirit or scope of the appended claims.

1. A system for approximate query processing of a database organized into records having attributes comprising:
a preprocessor that constructs, during a preprocessing phase, a plurality of different biased database samples by identifying records in the database having certain attribute values; and
a query processor which responds to a query during a runtime phase by dynamically selecting an appropriate data set from the number of different biased database samples and uses that data set to provide an approximate query answer to said query.

2. The system of claim 1 wherein the preprocessor scans the database to determine how many records have attribute values below a threshold for inclusion into the biased database samples.

3. The system of claim 2 wherein the plurality of biased database samples constructed by the preprocessor have different biases based on values for record attributes from the database.

4. The system of claim 3 wherein preprocessor indexes the multiple biased database samples for access by the query processor during processing of a query.

5. The system of claim 1 wherein the preprocessor creates a relatively uniform database sample from records contained in the database in addition to the biased samples and wherein the query processor also bases the approximate answer to a query based on the contents of both the biased samples and the uniform sample.

6. The system of claim 5 wherein the biased samples and the relatively uniform sample includes an appended attribute which is used by the query processor to avoid duplicate counting of records from the multiple biased samples and the uniform sample.

7. The system of claim 5 wherein the relatively uniform sample contains a fraction of the records in the database.

8. The system of claim 1 wherein each one of the multiple biased samples contain no more than a bias sample fraction of the records contained in the database.

9. The system of claim 1 wherein the biased samples contain an appended attribute which is used by the query processor to avoid duplicate counting of records from the multiple biased samples.

10. The system of claim 1 wherein the query processor provides the approximate answer to the query by aggregating records contained in the biased samples.

11. The system of claim 3 wherein all records containing a specified value or values are contained within a biased sample.

12. A process for approximate query processing of a database organized into records having attributes comprising:
constructing, during a preprocessing phase, a plurality of different biased database samples by identifying records in the database having certain attribute values; and
in response to a query during a runtime phase, providing an approximate result to a query by dynamically selecting an appropriate data set from the number of different biased database samples and using that data set to provide an approximate query answer to said query.

13. The process of claim 12 wherein the preprocessor scans the database to determine how many records have attribute values below a threshold for inclusion into the biased database samples.

14. The process of claim 13 wherein the selection of records to include in the plurality of biased samples is based on values for record attributes from the database.

15. The process of claim 14 wherein the multiple biased samples are indexed for access during processing of a query.

16. The process of claim 12 wherein during the preprocessor stage, a uniform sample from records contained in the database is prepared in addition to the biased samples and wherein the approximate query answer is based on the contents of both the biased samples and the uniform sample.

17. The process of claim 16 wherein the biased samples and the uniform sample contain an appended attribute which is used to avoid duplicate counting of records from the multiple biased samples and the uniform sample.

18. The process of claim 16 wherein the uniform sample is obtained by sampling a fraction of the records in the database.

19. The process of claim 13 wherein a threshold is established and wherein each one of the multiple biased samples contain no more than that threshold of the records contained in the database.

20. The process of claim 13 wherein an attribute is appended onto records contained within the biased samples which is used by in the query processing phase to avoid duplicate counting of records from the multiple biased samples.

21. The process of claim 14 wherein all records containing an attributes having a specified value or specified values are added to a specified biased sample.

22. A machine readable medium containing computer instructions for implementing an process of approximate query processing of a database organized into records having attributes comprising steps of:
constructing, during a preprocessing phase, a plurality of different biased database samples by identifying records in the database having certain attribute values; and
in response to a query during a runtime phase, providing an approximate result to a query by dynamically selecting an appropriate data set from the number of different biased database samples and using that data set to provide an approximate query answer to said query.

23. The machine readable medium of claim 22 wherein the preprocessor scans the database to determine how many records have attribute values below a threshold for inclusion into the biased database samples.

24. The machine readable medium of claim 23 wherein the selection of records to include in the plurality of biased samples is based on values for record attributes from the database.

25. The machine readable medium of claim 24 wherein the multiple biased samples are indexed for access during processing of a query.

26. The machine readable medium of claim 22 wherein during the preprocessor stage, a uniform sample from records contained in the database is prepared in addition to the biased samples and wherein the approximate query answer is based on the contents of both the biased samples and the uniform sample.

27. The machine readable medium of claim 26 wherein the biased samples and the uniform sample contain an appended attribute which is used to avoid duplicate counting of records from the multiple biased samples and the uniform sample.

28. The machine readable medium of claim 26 wherein uniform sample is obtained by sampling a fraction of the records in the database.

29. The machine readable medium of claim 23 wherein a threshold is established and wherein each one of the multiple biased samples contain no more than that threshold of the records contained in the database.

30. The machine readable medium of claim 23 wherein an attribute is appended onto records contained within the biased samples which is used by in the query processing phase to avoid duplicate counting of records from the multiple biased samples.

31. The machine readable medium of claim 24 wherein all records containing an attribute having a specified value or specified values are added to a specified biased sample.
